(19) United States
(12) Patent Application Publication
(10) Pub. No.: US 2025/0234329 A1
(43) Pub. Date: Jul. 17, 2025

(54) METHODS AND APPARATUSES FOR SIDELINK POSITIONING

(71) Applicant: Lenovo (Beijing) Limited, Beijing (CN)

(72) Inventors: Jie Hu, Beijing (CN); Jing Han, Beijing (CN); Lianhai Wu, Beijing (CN); Ran Yue, Beijing (CN); Min Xu, Beijing (CN)

(73) Assignee: Lenovo (Beijing) Limited, Beijing (CN)

(21) Appl. No.: 18/844,825

(22) PCT Filed: Apr. 1, 2022
(86) PCT No.: PCT/CN2022/084870

§ 371 Date: Sep. 6, 2024

(51) Int. Cl. H04W 64/00; H04W 24/10; H04W 76/40

(52) U.S. Cl. CPC H04W 64/003; H04W 24/10; H04W 76/40

(57) ABSTRACT

Embodiments of the present disclosure relate to methods and apparatuses for sidelink (SL) positioning. According to an embodiment of the present disclosure, a first user equipment (UE) may include: a receiver configured to receive SL positioning configuration information from a second UE, wherein the first UE helps the second UE to acquire its position; a transmitter configured to transmit a location information report to the second UE based on the positioning configuration information; and a processor coupled to the receiver and the transmitter.

### TECHNICAL FIELD

Embodiments of the present application generally relate to wireless communication technology, and especially to methods and apparatuses for sidelink (SL) positioning.

### BACKGROUND

SL positioning refers to transmitting positioning reference signal (PRS) over SL, which can operate independently of network or radio access technology (RAT) coverage and provide a new positioning method that fits new network use cases, such as vehicle-to-everything (V2X), public safety, commercial, industrial internet of things (IIOT), etc.

Service requirements for SL positioning have been defined in corresponding specification. Based on the specified requirements, solutions for SL positioning need be studied to support “both in coverage,” “partial coverage” and “both out of coverage” scenarios. Currently, details regarding location information reporting on SL need to be further discussed.

### SUMMARY OF THE APPLICATION

Embodiments of the present application at least provide technical solutions for SL positioning.

According to some embodiments of the present application, a first user equipment (UE) may include: a receiver configured to receive SL positioning configuration information from a second UE, wherein the first UE helps the second UE to acquire its position; a transmitter configured to transmit a location information report to the second UE based on the positioning configuration information; and a processor coupled to the receiver and the transmitter.

In some embodiments of the present application, the receiver is further configured to receive a location information request from the second UE, the location information request is used to request positioning measurements or a position estimate from the first UE, and the transmitter is configured to transmit the location information report to the second UE further based on the location information request.

In some embodiments of the present application, the receiver is further configured to receive a resource configuration indicating a dedicated reporting resource for transmitting the location information report to the second UE, and the resource configuration is received along with the location information request, or included in the location information request.

In some embodiments of the present application, the receiver is further configured to receive a groupcast signaling or broadcast signaling from the second UE or system information block (SIB) information, the groupcast signaling or broadcast signaling from the second UE or the SIB information includes a mapping relationship between a set of reporting resources and a set of UE identifications including an identification of the first UE, and the processor is configured to determine a dedicated reporting resource from the set of reporting resources for transmitting the location information report to the second UE based on the mapping relationship and the identification of the first UE.

In some embodiments of the present application, the receiver is further configured to receive inter-UE coordination information from the second UE, and the inter-UE coordination information indicates a dedicated reporting resource for transmitting the location information report to the second UE.

In some embodiments of the present application, the dedicated reporting resource includes at least one of: a time domain resource identified by a start time and an end time of a time window or a start time and a duration of a time window; a frequency domain resource; or a time-frequency domain resource.

In some embodiments of the present application, the location information request includes a response time specific for the first UE for a location service.

In some embodiments of the present application, the receiver is further configured to receive, from the second UE, a first configuration indicating an area associated with the first UE and a second configuration indicating that the area is associated with a dedicated reporting resource or a dedicated resource pool, and wherein the transmitter is configured to transmit the location information report to the second UE on the dedicated reporting resource or on a reporting resource in the dedicated resource pool.

In some embodiments of the present application, the processor is configured to: obtain an area mapping relationship between a set of areas and a set of UE identifications including an identification of the first UE, wherein the area mapping relationship is configured by the second UE or broadcasted in SIB information; and obtain a resource mapping relationship between the set of areas and a set of reporting resources or a set of resource pools, wherein the resource mapping relationship is configured by the second UE or broadcasted in SIB information; wherein the processor is configured to determine an area associated with the first UE from the set of areas based on the area mapping relationship and the identification of the first UE, and determine a dedicated reporting resource from the set of reporting resources or a dedicated resource pool from the set of resource pools based on the area associated with the first UE and the resource mapping relationship; and wherein the transmitter is configured to transmit the location information report to the second UE on the dedicated reporting resource or on a reporting resource in the dedicated resource pool.

In some embodiments of the present application, the area associated with the first UE includes at least one zone or a range centered on the first UE.

In some embodiments of the present application, the location information request includes a maximum retransmission number of the location information report.

In some embodiments of the present application, the transmitter is further configured to perform blind retransmission of the location information report until the maximum retransmission number is reached.

In some embodiments of the present application, the transmitter is further configured to retransmit the location information report in response to receiving an indication from the second UE indicating that the location information report is not successfully received by the second UE or in response to no feedback for the location information report being received from the second UE.

In some embodiments of the present application, the indication is a non-acknowledgement (NACK) feedback or a failure indication.

In some embodiments of the present application, the processor is configured to cancel the location information report when the maximum retransmission number is reached.

In some embodiments of the present application, the location information request indicates a scheduled location time and a response time, and the processor is configured to: perform a channel busy ratio (CBR) measurement within a time duration from the scheduled location time and an end of the response time or within a duration of the response time, and adapt transmission parameter(s) for transmitting the location information report based on the CBR measurement.

In some embodiments of the present application, the processor is configured to: start a timer in response to receiving the location information request, wherein a value of the timer is set based on a response time included in the location information request; and stop the timer in response to transmitting the location information report to the second UE.

In some embodiments of the present application, in the case that the first UE fails to transmit the location information report before the timer expires, the transmitter is further configured to: transmit an error indication to the second UE; or transmit a measurement report currently obtained by the first UE and a cause value for failing to transmit the location information report.

In some embodiments of the present application, the processor is configured to: start a timer in response to that the location information report becomes valid at the first UE, wherein a value of the timer is pre-configured for the first UE; and stop the timer in response to transmitting the location information report to the second UE.

In some embodiments of the present application, in the case that the first UE fails to transmit the location information report before the timer expires, the processor is further configured to cancel the location information report, and perform measurements in order to transmit a new location information report when the new location information report becomes valid.

In some embodiments of the present application, the transmitter is further configured to transmit a leaving indication to the second UE when at least one of the following conditions is satisfied: when a measured reference signal receiving power (RSRP) of sidelink positioning reference signal (SL-PRS) between the second UE and the first UE is smaller than or equal to a threshold within a time window; when a distance between the first UE and the second UE is larger than or equal to a threshold within a time window; when a CBR or a channel occupancy ratio (CR) measured by the first UE is larger than or equal to a threshold within a time window; or when the first UE moves to a different area.

In some embodiments of the present application, the leaving indication is included in the location information report, and wherein the location information report further includes a measurement report currently obtained by the first UE.

According to some other embodiments of the present application, a second UE may include: a transmitter configured to transmit SL positioning configuration information to a first UE, wherein the first UE helps the second UE to acquire its position; a receiver configured to receive a location information report from the first UE based on the positioning configuration information; and a processor coupled to the transmitter and the receiver.

In some embodiments of the present application, the transmitter is further configured to transmit a location information request to the first UE, the location information request is used to request positioning measurements or a position estimate from the first UE, and the receiver is configured to receive the location information report from the first UE further based on the location information request.

In some embodiments of the present application, the transmitter is further configured to transmit a resource configuration indicating a dedicated reporting resource for the first UE to transmit the location information report to the second UE, and wherein the resource configuration is transmitted along with the location information request, or included in the location information request.

In some embodiments of the present application, the transmitter is further configured to transmit a groupcast signaling or broadcast signaling or wherein the receiver is further configured to receive SIB information, the groupcast signaling or broadcast signaling or the SIB information includes a mapping relationship between a set of reporting resources and a set of UE identifications including an identification of the first UE, and the identification of the first UE is mapped to a dedicated reporting resource of the set of reporting resources for transmitting the location information report to the second UE.

In some embodiments of the present application, the transmitter is further configured to transmit inter-UE coordination information to the first UE, and the inter-UE coordination information indicates a dedicated reporting resource for the first UE to transmit the location information report to the second UE.

In some embodiments of the present application, the dedicated reporting resource includes at least one of: a time domain resource identified by a start time and an end time of a time window or a start time and a duration of a time window; a frequency domain resource; or a time-frequency domain resource.

In some embodiments of the present application, the location information request includes a response time specific for the first UE for a location service.

In some embodiments of the present application, the transmitter is further configured to transmit a first configuration indicating an area associated with the first UE and a second configuration indicating that the area is associated with a dedicated reporting resource or a dedicated resource pool, and wherein the receiver is configured to receive the location information report from the first UE on the dedicated reporting resource or on a reporting resource in the dedicated resource pool.

In some embodiments of the present application, the transmitter is further configured to: transmit, to the first UE, an area mapping relationship between a set of areas and a set of UE identifications including an identification of the first UE, wherein the area mapping relationship indicates that an area of the set of areas is associated with the first UE; and transmit, to the first UE, a resource mapping relationship between the set of areas and a set of reporting resources or a set of resource pools, wherein the resource mapping relationship indicates that the area associated with the first UE is associated with a dedicated reporting resource or a dedicated resource pool; and wherein the receiver is configured to receive the location information report on the dedicated reporting resource or on a reporting resource in the dedicated resource pool.

In some embodiments of the present application, the area associated with the first UE includes at least one zone or a range centered on the first UE.

In some embodiments of the present application, the location information request includes a maximum retransmission number of the location information report.

In some embodiments of the present application, the transmitter is further configured to: transmit, to the first UE, a first indication indicating a successful reception of the location information report in response to that the location information report is successfully received by the second UE; or transmit, to the first UE, a second indication indicating a failed reception of the location information report in response to that the location information report is not successfully received by the second UE.

In some embodiments of the present application, the first indication is an acknowledgement (ACK) feedback or a successful indication, and the second indication is a NACK feedback or a failure indication.

In some embodiments of the present application, the processor is configured to: start a timer in response to transmitting the location information request, wherein a value of the timer is set based on a response time included in the location information request; and stop the timer in response to receiving the location information report from the first UE.

In some embodiments of the present application, the transmitter is further configured to retransmit the location information request in response to expiration of the timer.

In some embodiments of the present application, the transmitter is further configured to: retransmit the location information request in response to receiving, from the first UE, an error indication or a measurement report with a cause value for failing to transmit the location information report.

In some embodiments of the present application, the receiver is further configured to receive a leaving indication from the first UE.

In some embodiments of the present application, the leaving indication is included in the location information report including a measurement report.

According to some other embodiments of the present application, a method performed by a first UE may include: receiving SL positioning configuration information from a second UE, wherein the first UE helps the second UE to acquire its position; and transmitting a location information report to the second UE based on the positioning configuration information.

According to some other embodiments of the present application, a method performed by a second UE may include: transmitting SL positioning configuration information to a first UE, wherein the first UE helps the second UE to acquire its position; and receiving a location information report from the first UE based on the positioning configuration information.

Embodiments of the present application provide technical solutions for SL positioning, which include but are not limited to apparatuses and methods for location information reporting for SL positioning.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary UE-configured and UE-based SL positioning architecture according to some embodiments of the present application;

FIG. 3 illustrates an exemplary location information transfer procedure between a UE and a server;

FIG. 4 illustrates an exemplary location information delivery procedure between a UE and a server;

FIG. 5 illustrates an exemplary timeline for location information reporting according to some embodiments of the present application;

FIG. 6 is a flow chart illustrating an exemplary method for SL positioning according to some embodiments of the present application;

FIG. 7 is a flow chart illustrating an exemplary method for SL positioning according to some other embodiments of the present application; and

FIG. 8 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

FIG. 1 is a schematic diagram illustrating an exemplary wireless communication system 100 according to some embodiments of the present application.

As shown in FIG. 1, the wireless communication system 100 includes at least one base station (BS) 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network, which is known as Uu positioning or NR Uu positioning.

SL positioning refers to transmit PRS over sidelink, which can operate independent of network or RAT coverage. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. According to some other embodiments of the present application, the anchor UE(s) may be determined by the network (e.g., by a location management function (LMF) or a BS) instead of being selected by the target UE. In such embodiment, the target UE and the anchor UE(s) may be in coverage of the network. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

For example, the UE 102a may act as an SL target UE. The UE 102a may select the UE 102b to be an SL anchor UE to assist the UE 102a to acquire its position, which is in the “both in coverage” scenario. Alternatively or additionally, the UE 102a may select the UE 102c to be an SL anchor UE to assist the UE 102a to acquire its position, which is in the “partial coverage” scenario. It should be understood that the UE 102a may alternatively or additionally select other SL anchor UE(s) not shown in FIG. 1.

In another example, the UE 102d may act as an SL target UE. The UE 102d may select the UE 102b to be an SL anchor UE to assist the UE 102d to acquire its position, which is in the “partial coverage” scenario. Alternatively or additionally, the UE 102d may select the UE 102c to be an SL anchor UE to assist the UE 102d to acquire its position, which is in the “both out of coverage” scenario. It should be understood that the UE 102d may alternatively or additionally select other SL anchor UE(s) not shown in FIG. 1. The SL anchor UE(s) selected by the UE 102d may be different from the SL anchor UE(s) selected by the UE 102a.

The SL positioning may include sidelink positioning configuration transmission, SL-PRS transmission and measurement, and position calculation. The UE-configured and UE-based SL positioning may refer to that all sidelink positioning operations (e.g., sidelink positioning configuration transmission, SL-PRS transmission and measurement, and position calculation) are done by the target or anchor UEs participating in the sidelink positioning. In the UE-configured and UE-based SL positioning, the target UE and the anchor UEs may form a sidelink positioning group, and transmit or receive SL-PRS to calculate the target UE's location information based on UE measurements.

In the UE-configured and UE-based SL positioning, neither Uu link nor network-based location server is involved. The UE-configured and UE-based SL positioning is a fully distributed positioning based on the “positioning group,” which may include at least one of: vehicles, VRUs or RSUs. Anchor UE(s) (e.g., RSU(s)) in the positioning group may play a role as a location server operated by a road operator.

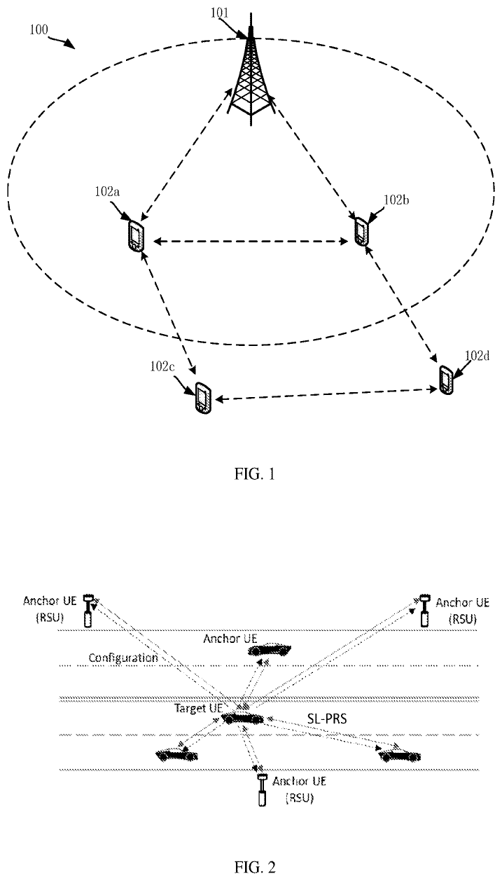

FIG. 2 illustrates an exemplary UE-configured and UE-based SL positioning architecture according to some embodiments of the present application.

Referring to FIG. 2, a target UE may determine six anchor UEs to help the target UE to acquire its position, wherein three anchor UEs are RSUs and the remaining three anchor UEs are vehicles. The target UE and the six anchor UEs may form a sidelink positioning group. The target UE may transmit positioning configuration information to each of the anchor UEs, and then SL-PRS transmission and measurement may be performed between the target UE and each of the anchor UEs. For example, each of the anchor UEs may receive SL-PRS from the target UE, perform measurement based on the SL-PRS, and transmit measurement results to the target UE. Then, the target UE may use the measurement results from the anchor UEs to calculate its position. Alternatively or additionally, the anchor UE may calculate a position estimate based on the SL-PRS and transmit the position estimate to the target UE. In some other examples, the anchor UE may transit SL-PRS to the target UE, and the target UE may perform measurement based on the SL-PRS.

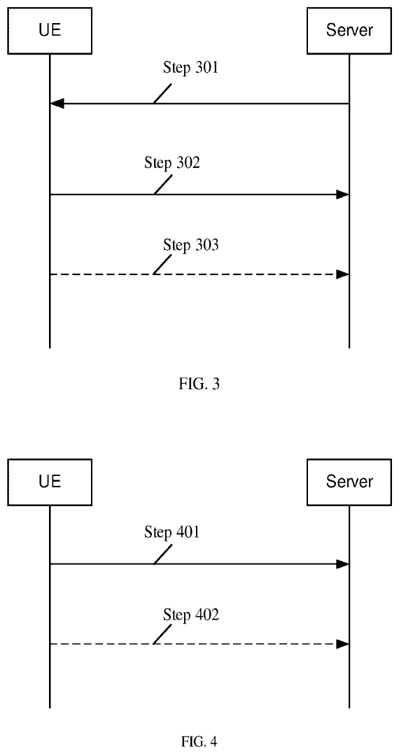

In an NR Uu positioning procedure, a UE may transmit location information based on a request message from a server (also referred to as “location server” or “LCS server”) or the UE may provide unsolicited location information to the server. FIG. 3 and FIG. 4 illustrate the above two procedures, respectively.

Specifically, FIG. 3 illustrates an exemplary location information transfer procedure between a UE and a server.

Referring to FIG. 3, in step 301, the server may transmit a location information request message (e.g., RequestLocationInformation message) to the UE to request location information. The location information request message may indicate a type of location information needed and potentially the associated quality of service (QoS). For example, the location information request message may indicate that the needed location information is positioning measurements (also referred to as location measurements), position estimate (also referred to as location estimate), or positioning measurements and position estimate.

After receiving the location information request message, in step 302, the UE may transmit location information report message (e.g., ProvideLocationInformation message) to the server to transfer location information. The location information transferred may match or may be a subset of the location information requested in step 301 unless the server explicitly allows additional location information. If step 303 does not occur, this message may set an “endTransaction” information element (IE) in the location information report message to be “TRUE.”

If additional location information report message(s) is requested in step 301, in step 303, the UE may transmit additional location information report message(s) (e.g., additional ProvideLocationInformation message(s)) to the server to transfer location information. The location information transferred may match or be a subset of the location information requested in step 301 unless the server explicitly allows additional location information. The last message in step 303 may include the endTransaction IE which is set to be “TRUE.”

FIG. 4 illustrates an exemplary location information delivery procedure between a UE and a server. Specifically, the procedure in FIG. 4 allows the UE to provide unsolicited location information to the server.

Referring to FIG. 4, in step 401, the UE may transmit location information report message (e.g., ProvideLocationInformation message) to the server to transfer location information. If step 402 does not occur, this message may set an “endTransaction” IE in the location information report message to be “TRUE.”

In step 402, the UE may transmit one or more additional location information report messages (e.g., additional ProvideLocationInformation messages) which contain additional location information data to the server. The last message in step 402 may include the endTransaction IE which is set to be “TRUE.”

In NR Uu positioning, a scheduled location time and a response time may be included in the location information request message (e.g., RequestLocationInformation message) to grantee the server to acquire the measured location information within the latency bound.

For example, the scheduled location time may define a desired time when the location measurements or location estimate is to be obtained (or valid). The scheduled location time may be an absolute time, e.g., universal time coordinated (UTC) time, global navigation satellite system (GNSS) time, network time, or any other time.

The response time may indicate a maximum response time as measured between the reception of location information request message (e.g., RequestLocationInformation message) and the transmission of location information report message (e.g., ProvideLocationInformation message). The response time may be a time period or a time window, which is represented by an integer number of time units. For example, a time unit may be 1 ms, 10 ms, 1 s, 10 s, or any other values.

In SL positioning, an anchor UE may transmit location information based on a location information request from a target UE or the anchor UE may provide unsolicited location information to the target UE. However, if the scheduled location time is introduced for SL positioning as that for NR Uu positioning, it may cause the time for each anchor UE within a sidelink positioning group to perform measurement reporting to overlap with each other, which exacerbates resource conflicts and affects positioning performance.

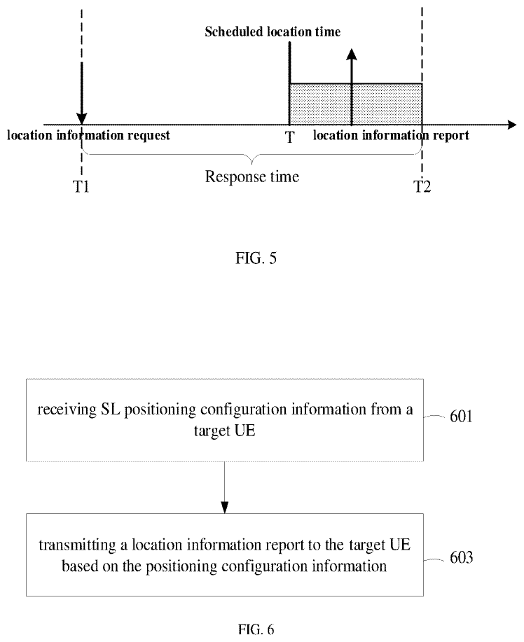

For example, FIG. 5 illustrates an exemplary timeline for location information reporting according to some embodiments of the present application.

Referring to FIG. 5, it is assumed that anchor UE(s) within an SL positioning group receives a location information request from a target UE at a time T1 and the location information request indicates a response time. Then, the anchor UE(s) should transmit a location information report no later than a time T2=T1+response time.

In the case that no “scheduled location time” is indicated by the location information request, the anchor UE(s) may perform location measurements distributed over the response time (e.g., [T1, T2]) and transmit the location information report as soon as the requested location information is available, but no later than T2. That is, the location information from the anchor UE(s) can be reported anywhere within the response time [T1, T2] by each anchor UE's implementation and may be an “average” between the first and last measurements performed by the anchor UE(s).

In the case that a scheduled location time (represented by “T” in FIG. 5) is indicated by the location information request, the time for the measurements to be available (or obtained) is provided to the anchor UE(s) in advance, which can reduce the effective latency in providing location information report and make all measurements from different anchor UEs valid for the same time T.

However, each anchor UE within the positioning group has location measurements available/valid for the same time T, which may cause the time for each anchor UE to prepare, perform and/or report the measurements to overlap with each other, and thus resource conflicts, channel congestions, etc. may happen. High probability of conflicts may seriously affect the reporting delay, and thus the high accuracy and low latency performances may be difficult to be guaranteed for sidelink positioning.

In addition, the scheduled location time T also causes the reporting time window for each anchor UE to be reduced, e.g., from [T1, T2] to [T, T2]), which means that the available resources for reporting the location information are decreased greatly. For example, it is assumed that the sidelink positioning group includes 5 anchor UEs, the response time is 10 ms and the scheduled location time T is determined to be at 8 ms within the response time. Then, the reporting time window for 5 anchor UEs is changed from 10 ms to 2 ms. Since each anchor UE may have the location measurements available at time T and then transmit the location information report as soon as the requested location information is available, each anchor UE may perform mode 2 resource selection (which is performed based on a sensing-based resource selection procedure) almost at the same time in the limited resource pool, and thus the probability of resource collisions is increased.

Given the above, the above resource conflict problem caused by introducing the “scheduled location time” for SL positioning needs to be addressed.

Moreover, for explicit request based location information reporting, a response time may be signaled in the location information request message from a target UE to each anchor UE within a sidelink positioning group, and each anchor UE needs to transmit a location information report to the target UE within the response time. For a specific target location service, the response time for each anchor UE within the sidelink positioning group is the same, but the actual reporting time from each anchor UE may be different within the response time.

For unsolicited location information reporting without an explicit request, no response time or scheduled location time is indicated to anchor UE(s), and each anchor UE may measure the location information by its own implementation and transmit the generated location information to the target UE when some specified conditions are satisfied. In order to ensure the received location information by the target UE is not outdated and guarantee the positioning accuracy, the location information should also be transmitted to the target UE within a latency bound.

Given the above, it is desired to make the location information reporting to be transmitted within a latency bound to ensure the positioning latency requirements for both explicit request based location information reporting and unsolicited location information reporting.

In addition, for a sidelink positioning group, one or more anchor UEs can be configured or determined to perform measurements on received SL-PRS within the group and perform reporting within the group. Considering that the target UE and the anchor UE(s) may be moving UEs, the sidelink positioning group may be dynamic, and thus the measurement quality may change with external conditions, which also affects the positioning accuracy. Given this, it is also desired to make the target UE to know that an anchor UE is leaving the current sidelink positioning group so as to avoid keeping monitor the measurement results with accuracy or latency problems.

Embodiments of the present application provide various technical solutions for SL positioning, which can solve at least one of the above technical problems. More details will be described in the following text in combination with the appended drawings.

FIG. 6 is a flow chart illustrating an exemplary method for SL positioning according to some embodiments of the present application. The method illustrated in FIG. 6 may be performed by an anchor UE. The anchor UE may refer to a UE that participates in SL positioning and helps a target UE to acquire its position, e.g., by sending/receiving SL PRS and doing relevant measurements. The target UE may refer to a UE at which a location service request is initiated or occurs. In other words, the target UE may refer to a UE that wants to know its own position. The anchor UE and the target UE may be included in a SL positioning group. In some embodiments, the SL positioning group may also include one or more other anchor UEs. Persons skilled in the art can understand that the method described with respect to the anchor UE can be implemented by other apparatus with the like functions.

In the exemplary method shown in FIG. 6, in step 601, the anchor UE may receive SL positioning configuration information from the target UE, e.g., via a groupcast manner, a broadcast manner, or a unicast manner. The SL positioning configuration information may include at least one of: configuration information regarding SL-PRS, configuration information regarding the measurement, configuration information regarding reporting, and so on. For example, the SL positioning configuration information may include at least one of:
information for transmitting or receiving SL-PRS: for example, information for transmitting or receiving SL-PRS may include parameters related to: when to transmit or receive the SL-PRS and which resources to be used to transmit or receive the SL-PRS, e.g., the parameters may include periodicity for transmitting or receiving SL-PRS, bandwidth transmitting or receiving SL-PRS, reception time of SL-PRS, etc.;
information for measuring the SL-PRS: for example, the information for measuring the SL-PRS may include: SL-PRS measurement window, measurement index, etc.; or
information for reporting a measurement result of the SL-PRS: for example, the information for reporting a measurement result of the SL-PRS may include at least one of: the content to be reported, the periodicity for reporting the measurement result, the event for reporting the measurement result, etc.

After receiving the SL positioning configuration information, the anchor UE may receive SL-PRS from the target UE and perform measurement on the SL-PRS based on the SL positioning configuration information. Then, in step 603, the anchor UE may transmit a location information report based on the positioning configuration information.

According to some embodiments of the present application, the location information report may be transmitted based on a location information request from the target UE. In such embodiments, before transmitting the location information report, the anchor UE may receive the location information request from the target UE. The location information request is used to request positioning measurements or a position estimate from the anchor UE. In an embodiment of the present application, the location information request may indicate a type of required location information and potentially QoS associated with the required location information. For example, the location information request may indicate at least one of the following types of required location information: positioning measurements (also referred to as location measurements), or position estimate (also referred to as location estimate). Then, in step 603, the anchor UE may transmit the location information report to the target UE further based on the location information request.

In such embodiments, in order to alleviate the resource conflict caused by multiple anchor UEs in the sidelink positioning group, dedicated resource or dedicated resource pool may be configured for the anchor UE to transmit the location information report. The following embodiments illustrate how to configure dedicated resource or dedicated resource pool for the anchor UE.

In some embodiments of the present application, the anchor UE may receive a resource configuration from the target UE via a unicast manner. The resource configuration may indicate a dedicated reporting resource for transmitting the location information report to the target UE. The dedicated reporting resource may include at least one of: a time domain resource identified by a start time and an end time of a time window or a start time and a duration of a time window; a frequency domain resource; or a time-frequency domain resource.

In an embodiment of the present application, the resource configuration is received along with the location information request. In another embodiment of the present application, the resource configuration is included in the location information request. In yet another embodiment of the present application, the location information request may be contained in a radio resource control (RRC) reconfiguration sidelink message.

After receiving the resource configuration, in step 603, the anchor UE may transmit the location information report on the dedicated reporting resource indicated by the resource configuration.

In some other embodiments of the present application, the anchor UE may receive a groupcast signaling or broadcast signaling from the target UE. Alternatively, the UE may receive SIB information from a BS. The groupcast signaling or broadcast signaling from the target UE or the SIB information may include a mapping relationship between a set of reporting resources and a set of UE identifications including an identification of the anchor UE. Each reporting resource may be associated with an identification of a corresponding UE such that the corresponding UE may use its associated reporting resource to transmit the location information report. Each reporting resource may include at least one of: a time domain resource identified by a start time and an end time of a time window or a start time and a duration of a time window; a frequency domain resource; or a time-frequency domain resource.

After receiving the mapping relationship, the anchor UE may determine a dedicated reporting resource from the set of reporting resources for transmitting the location information report to the target UE based on the mapping relationship and the identification of the anchor UE. For example, based on the identification of the anchor UE, the anchor UE may determine a dedicated reporting resource associated with the identification of the anchor UE indicated by the mapping relationship, and then, in step 603, the UE may transmit the location information report on the dedicated reporting resource.

In some cases, inter-UE coordination information is introduced in Rel-17 sidelink. The inter-UE coordination information may indicate a set of resources (e.g., preferred or non-preferred resource) determined at one UE and then transmitted to another UE which performs mode 2 resource selection. The another UE may take the set of resources into account in the resource selection for its own transmission.

According to some embodiments of the present application, the inter-UE coordination information may be used by the target UE for conveying a dedicate reporting resource to the anchor UE. In such embodiments, the anchor UE may receive the inter-UE coordination information from the target UE. The inter-UE coordination information may indicate a dedicated reporting resource for transmitting the location information report to the target UE. The dedicated reporting resource may include at least one of: a time domain resource identified by a start time and an end time of a time window or a start time and a duration of a time window; a frequency domain resource; or a time-frequency domain resource. After receiving the inter-UE coordination information, in step 603, the anchor UE may transmit the location information report on the dedicated reporting resource indicated by the inter-UE coordination information.

In some embodiments of the present application, the location information request received in step 601 may include a response time specific for the anchor UE for a location service. After receiving the location information request, in step 603, the anchor UE may transmit the location information report within the specific response time.

In an embodiment of the present application, in addition to the response time, the location information request may also include a scheduled location time specific for the anchor UE for the location service. After receiving the location information request, the anchor UE may transmit the location information report within a time duration from the scheduled location time to an end of the response time.

In some other embodiments of the present application, the anchor UE may receive a first configuration indicating an area associated with the anchor UE from the target UE. In an embodiment, the area associated with the anchor UE includes at least one zone, or a range centered on the anchor UE, or other forms of area associated with the anchor UE. For example, the first configuration may be configured to the anchor UE when the target UE performs anchor UE selection or reselection. In addition, the anchor UE may also receive a second configuration (e.g., a resource mapping relationship between area(s) and reporting resource(s) or resource pool(s)) indicating that the area associated with the anchor UE is associated with a dedicated reporting resource or a dedicated resource pool from the target UE. After receiving the first configuration and the second configuration, the anchor UE may transmit the location information report to the target UE on the dedicated reporting resource or on a reporting resource in the dedicated resource pool.

In some other embodiments of the present application, the anchor UE may receive an area mapping relationship between a set of areas and a set of UE identifications including an identification of the anchor UE. In an embodiment, the area mapping relationship may be configured by the target UE (e.g., via a groupcast signaling or broadcast signaling transmitted from the target UE). In another embodiment, the area mapping relationship may be broadcasted in SIB information. In an embodiment, each area is associated with an identification of a corresponding UE, and includes at least one zone or a range centered on the corresponding UE, or other forms of area associated with the corresponding UE.

In addition, the anchor UE may also receive a resource mapping relationship between the set of areas and a set of reporting resources or a set of resource pools. In an embodiment, the resource mapping relationship may be configured by the target UE (e.g., via a groupcast signaling or broadcast signaling transmitted from the target UE). In another embodiment, the resource mapping relationship may be broadcasted in SIB information.

After receiving the area mapping relationship and resource mapping relationship, the anchor UE may determine an area associated with the anchor UE from the set of areas based on the area mapping relationship and the identification of the anchor UE, and then determine a dedicated reporting resource from the set of reporting resources or a dedicated resource pool from the set of resource pools based on the area associated with the anchor UE and the resource mapping relationship. For example, the anchor UE may determine an area associated with the identification of the anchor UE as indicated by the area mapping relationship, and then determine a dedicated reporting resource or a dedicated resource pool associated with the determined area as indicated by the resource mapping relationship.

After determining the dedicated reporting resource or dedicated resource pool, the anchor UE may transmit the location information report to the target UE on the dedicated reporting resource or on a reporting resource in the dedicated resource pool.

According to some embodiments of the present application, the location information request received in step 601 may include a maximum retransmission number of the location information report.

In some embodiments, after transmitting the location information report in step 603, the anchor UE may perform blind retransmission of the location information report until the maximum retransmission number indicated by the location information request is reached, and then the anchor UE may cancel the location information report.

In some other embodiments, after transmitting the location information report in step 603, the anchor UE may perform retransmission of the location information report based on a feedback from the target UE.

In an embodiment, hybrid automatic repeat request (HARQ) feedback over sidelink may be used to indicate whether the location information report is successfully received by the target UE. For example, the HARQ feedback may be one of the following:
ACK/NACK feedback: ACK for successful reporting and NACK for failure reporting;
NACK only feedback: NACK for failure reporting and no feedback for successful reporting; and
ACK only feedback: ACK for successful reporting and no feedback for failure reporting.

In another embodiment, a feedback indication different from the HARQ feedback may be designed to indicate whether the location information report is successfully received by the target UE. For example, the feedback indication may be an RRC layer indication or LTE positioning protocol (LPP) layer indication. Similar to the HARQ feedback, the feedback indication may include one of:
Success indication/failure indication: success indication for successful reporting and failure indication for failure reporting;
Failure indication only: failure indication for failure reporting and no feedback for successful reporting; and
Success indication only: success indication for successful reporting and no feedback for failure reporting.

Given the above, in the case that the location information report transmitted in step 603 is successfully received by the target UE, the anchor UE may receive a first indication indicating a successful reception of the location information report by the target UE (e.g., in the case of ACK/NACK feedback or ACK only feedback) or the anchor UE does not receive any feedback (e.g., in the case of NACK only feedback). In such cases, the first indication may be an ACK feedback, a successful indication, or other indication indicating a successful reception of the location information report

In the case that the location information report transmitted in step 603 is not successfully received by the target UE, the anchor UE may receive a second indication indicating a failed reception of the location information report (e.g., in the case of ACK/NACK feedback or NACK only feedback) or the anchor UE does not receive any feedback (e.g., in the case of ACK only feedback). In such cases, the second indication may be a NACK feedback, a failure indication, or other indication indicating a failed reception of location information reporting. Then, the anchor UE may perform resource reselection to retransmit the location information report in response to receiving the second indication or in response to no feedback for the location information report being received from the target UE. In such cases, the anchor UE may repeatedly perform the retransmission in the case that the location information report is not successfully received by the target UE and the maximum retransmission number is not reached. The anchor UE may cancel the location information report when the maximum retransmission number is reached.

According to some other embodiments of the present application, the location information request received in step 601 may indicate a scheduled location time and a response time. Then, the anchor UE may perform a CBR measurement within a time duration from the scheduled location time and an end of the response time or within a duration of the response time, and adapt transmission parameter(s) for transmitting the location information report based on the CBR measurement.

The embodiments described above may solve the resource conflict caused by multiple anchor UEs in an SL positioning group, thereby improving the sidelink positing performance.

The following embodiments may relate to ensuring latency bound for location information reporting to guarantee latency requirement for both explicit request based location information reporting scenario and non-explicit request based (e.g., unsolicited) location information reporting scenario.

In the explicit request based location information reporting scenario, as stated above, before transmitting the location information report, the anchor UE may receive the location information request from the target UE.

The anchor UE may start a timer in response to receiving the location information request, wherein a value of the timer is set based on (for example, equal to or less than) a response time included in the location information request. The anchor UE may stop the timer in response to transmitting the location information report to the target UE in step 603.

In some embodiments, in the case that the anchor UE fails to transmit the location information report before the timer expires, the anchor UE may transmit an error indication with or without a cause value for failing to transmit the location information report to the target UE. Alternatively, in the case that the anchor UE fails to transmit the location information report before the timer expires, the anchor UE may transmit a measurement report currently obtained by the anchor UE (e.g., measured information that can be provided currently by the anchor UE) and a cause value for failing to transmit the location information report to the target UE.

In some other embodiments, in the case that the anchor UE fails to transmit the location information report before the timer expires, the anchor UE may cancel the location information report, and perform measurements in order to transmit a new location information report when a new location information request is received.

In the non-explicit request based (e.g., unsolicited) location information reporting scenario, according to some embodiments of the present application, a value of a latency timer (or bound) for non-explicit request based location information reporting is pre-configured for the anchor UE to ensure the generated location information report is delivered on time. The value of the latency timer being pre-configured for the anchor UE may refer to that: the value of the latency timer may be hard-wired into the anchor UE or stored on a subscriber identity module (SIM) or universal subscriber identity module (USIM) card for the anchor UE, such that the anchor UE may obtain the value of the latency timer within the anchor UE.

In such scenario, the anchor UE may start the latency timer in response to that the location information report becomes valid at the anchor UE. The anchor UE may stop the timer in response to transmitting the location information report to the target UE in step 603.

In some embodiments, in the case that the anchor UE fails to transmit the location information report before the timer expires, the anchor UE may cancel the location information report, and perform measurements in order to transmit a new location information report when the new location information report becomes valid.

In some embodiments, for unsolicited periodic location information reporting, the value of the latency timer may be pre-configured for the first location information reporting, and subsequent location information reporting may follow a reporting interval which may be configured by the target UE or pre-configured for the anchor UE.

In the non-explicit request based (e.g., unsolicited) location information reporting scenario, according to some other embodiments of the present application, the anchor UE may transmit the location information report up to the anchor UE's implementation.

According to some embodiments of the present application, a leaving indication may be introduced to inform the target UE when the anchor UE is leaving the current sidelink positioning group.

For example, the anchor UE may transmit a leaving indication to the target UE when at least one of the following conditions is satisfied:
when a measured RSRP of SL-PRS between the target UE and the anchor UE is smaller than or equal to a threshold within a time window, where the threshold and/or the duration of the time window may be configured by the target UE or pre-configured for the anchor UE;
when a distance between the anchor UE and the target UE is larger than or equal to a threshold within a time window, where the threshold and/or the duration of the time window may be configured by the target UE or pre-configured for the anchor UE;
when a CBR or a CR measured by the anchor UE is larger than or equal to a threshold within a time window, where the threshold and/or the duration of the time window may be configured by the target UE or pre-configured for the anchor UE; or
when the anchor UE moves to a different area from the current area: for example, the different area may be a zone-based area (e.g., at least one zone), or RSU-centric area (e.g., an area centered with an RSU), or range-based area (e.g., a range), or other forms of area.

According to some embodiments of the present application, the anchor UE may transmit the leaving indication without providing location information along with the leaving indication to the target UE.

According to some other embodiments of the present application, the leaving indication may be included in the location information report transmitted in step 603, and the location information report may further include a measurement report currently obtained by the anchor UE (e.g., measured information that can be provided currently by the anchor UE). Alternatively, the leaving indication may be included in another message which further includes a measurement report currently obtained by the anchor UE (e.g., measured information that can be provided currently by the anchor UE).

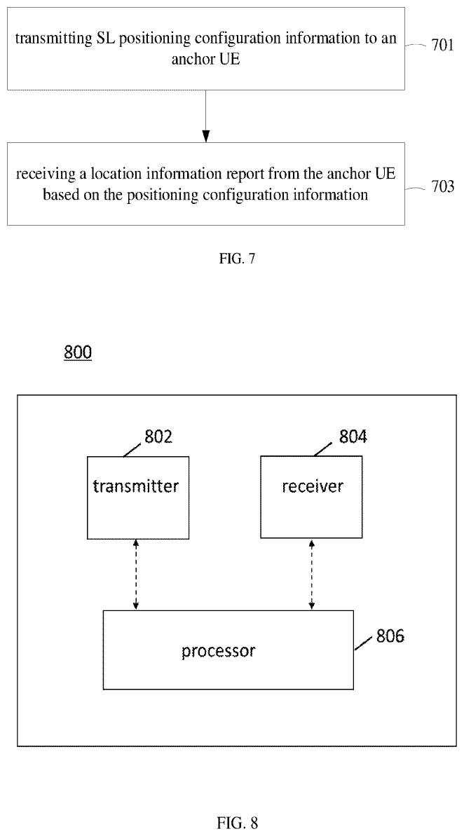

FIG. 7 is a flow chart illustrating an exemplary method for SL positioning according to some other embodiments of the present application. The method illustrated in FIG. 7 may be performed by a target UE. The target UE may refer to a UE at which a location service request is initiated or occurs. In other words, the target UE may refer to a UE that wants to know its own position. Persons skilled in the art can understand that the method described with respect to the target UE can be implemented by other apparatus with the like functions.

In the exemplary method shown in FIG. 7, in step 701, the target UE may transmit SL positioning configuration information to an anchor UE, e.g., via a groupcast manner, a broadcast manner, or a unicast manner. The anchor UE may refer to a UE that participates in SL positioning and helps the target UE to acquire its position, e.g., by sending/receiving SL PRS and doing relevant measurements.

In some embodiments, the anchor UE and the target UE may be included in a SL positioning group, and the SL positioning group may also include one or more other anchor UEs. In such embodiments, the target UE may transmit the SL positioning configuration information to each anchor UE in the SL positioning group. For simplicity, the following embodiments take the anchor UE as an example, and the operations performed with respect to the anchor UE may also apply for other anchor UE(s) in the SL positioning group.

The content included in the SL positioning configuration information transmitted in step 701 may be the same as that included in the SL positioning configuration information received in step 601 of FIG. 6.

After transmitting the SL positioning configuration information, the target UE may transmit SL-PRS based on the SL positioning configuration information. Then, in step 703, the target UE may receive a location information report based on the positioning configuration information.

According to some embodiments of the present application, before receiving the location information report, the target UE may transmit a location information request to the anchor UE. The location information request is used to request positioning measurements or a position estimate from the anchor UE. In an embodiment of the present application, the location information request may indicate a type of required location information and potentially QoS associated with the required location information. For example, the location information request may indicate at least one of the following types of required location information: positioning measurements (also referred to as location measurements), or position estimate (also referred to as location estimate). Then, in step 703, the target UE may receive the location information report from the anchor UE further based on the location information request.

In such embodiments, in order to alleviate the resource conflict caused by multiple anchor UEs in the sidelink positioning group, the target UE or a BS may configure dedicated resource or dedicated resource pool for the anchor UE to transmit the location information report. The following embodiments illustrate how to configure dedicated resource or dedicated resource pool for the anchor UE. Persons skilled in the art can understand that the operations performed with respect to the anchor UE may also apply for other anchor UE(s) in the SL positioning group.

In some embodiments of the present application, the target UE may transmit a resource configuration to the anchor UE via a unicast manner. The resource configuration may indicate a dedicated reporting resource for transmitting the location information report to the target UE. The dedicated reporting resource may include at least one of: a time domain resource identified by a start time and an end time of a time window or a start time and a duration of a time window; a frequency domain resource; or a time-frequency domain resource.

In an embodiment of the present application, the resource configuration is transmitted along with the location information request. In another embodiment of the present application, the resource configuration is included in the location information request. In yet another embodiment of the present application, the location information request may be contained in an RRC reconfiguration sidelink message.

After transmitting the resource configuration, in step 703, the target UE may receive the location information report on the dedicated reporting resource from the anchor UE.

In some other embodiments of the present application, the target UE may transmit a groupcast signaling or broadcast signaling to a set of UEs (including the anchor UE) in the SL positioning group. Alternatively, the BS may transmit SIB information to UEs, which may include the target UE and the anchor UE. The groupcast signaling or broadcast signaling transmitted by the target UE or the SIB information may include a mapping relationship between a set of reporting resources and a set of UE identifications including an identification of the anchor UE. Each reporting resource may be associated with an identification of a corresponding UE such that the corresponding UE may use its associated reporting resource to transmit the location information report. Each reporting resource may include at least one of: a time domain resource identified by a start time and an end time of a time window or a start time and a duration of a time window; a frequency domain resource; or a time-frequency domain resource.

For example, the identification of the anchor UE may be mapped to a dedicated reporting resource of the set of reporting resources for transmitting the location information report to the target UE as indicated by the mapping relationship. Accordingly, in step 703, the target UE may receive the location information report from the anchor UE on the dedicated reporting resource.

In some other embodiments of the present application, the target UE may transmit inter-UE coordination information to the anchor UE. The inter-UE coordination information may indicate a dedicated reporting resource for transmitting the location information report from the anchor UE. The dedicated reporting resource may include at least one of: a time domain resource identified by a start time and an end time of a time window or a start time and a duration of a time window; a frequency domain resource; or a time-frequency domain resource. After transmitting the inter-UE coordination information, in step 703, the target UE may receive the location information report from the anchor UE on the dedicated reporting resource indicated by the inter-UE coordination information.

In some embodiments of the present application, the target UE may divide a dedicated resource for each anchor UE within a time duration from a scheduled location time T to an end of a response time T2, i.e., [T, T2], by the target UE's implementation. For example, the target UE may divide the reporting resources within time duration [T, T2] into N reporting resources, and each reporting resource may be associated with a corresponding anchor UE. Then, the target UE may indicate a reporting resource to a corresponding anchor UE via a unicast manner as stated above, or the target UE may transmit a mapping relationship between the N reporting resources and N anchor UEs via the groupcast signaling or broadcast signaling as stated above.

In some embodiments of the present application, the location information request transmitted in step 701 may include a response time specific for the anchor UE for a location service. After transmitting the location information request, in step 703, the target UE may receive the location information report from the anchor UE within the specific response time.

In an embodiment of the present application, in addition to the response time, the location information request may also include a scheduled location time specific for the anchor UE for the location service. After transmitting the location information request, the target UE may receive the location information report from the anchor UE within a time duration from the scheduled location time to an end of the response time.

In some other embodiments of the present application, the target UE may transmit a first configuration indicating an area associated with the anchor UE. In an embodiment, the area associated with the anchor UE includes at least one zone, or a range centered on the anchor UE, or other forms of area associated with the anchor UE. For example, the first configuration may be configured to the anchor UE when the target UE performs anchor UE selection or reselection. In addition, the target UE may also transmit a second configuration (e.g., a resource mapping relationship between area(s) and reporting resource(s) or resource pool(s)) indicating that the area associated with the anchor UE is associated with a dedicated reporting resource or a dedicated resource pool from the target UE. After transmitting the first configuration and the second configuration, the target UE may receive the location information report from the anchor UE on the dedicated reporting resource or on a reporting resource in the dedicated resource pool.

In some other embodiments of the present application, the target UE may transmit, to a set of UEs (including the anchor UE) in the SL positioning group, an area mapping relationship between a set of areas and a set of UE identifications including an identification of the anchor UE. For example, the target UE may transmit the area mapping relationship via a groupcast signaling or broadcast signaling. Alternatively, the BS may transmit SIB information including the area mapping relationship to UEs, which include the target UE and the anchor UE. In an embodiment, each area is associated with an identification of a corresponding UE), and includes at least one zone or a range centered on the corresponding UE, or other forms of area associated with the corresponding UE.

In addition, the target UE may also transmit, to the set of UEs, a resource mapping relationship between the set of areas and a set of reporting resources or a set of resource pools. For example, the target UE may transmit the resource mapping relationship via a groupcast signaling or broadcast signaling. Alternatively, the BS may transmit SIB information including the resource mapping relationship to UEs, which include the target UE and the anchor UE.

For example, the identification of the anchor UE is mapped to an area and the area is mapped to a dedicated reporting resource or a dedicated resource pool for transmitting the location information report to the target UE as indicated by the area mapping relationship and the resource mapping relationship. Accordingly, in step 703, the target UE may receive the location information report on the dedicated reporting resource or on a reporting resource in the dedicated resource pool.

According to some embodiments of the present application, the location information request transmitted in step 701 may include a maximum retransmission number of the location information report.

In some embodiments of the present application, the target UE may transmit a feedback to the anchor UE to indicate whether the location information report is successfully received.

In some embodiments, HARQ feedback over sidelink may be used to indicate whether the location information report is successfully received by the target UE. For example, the HARQ feedback may be one of the following:
ACK/NACK feedback: ACK for successful reporting and NACK for failure reporting;
NACK only feedback: NACK for failure reporting and no feedback for successful reporting; and
ACK only feedback: ACK for successful reporting and no feedback for failure reporting.

In another embodiment, a feedback indication different from the HARQ feedback may be designed to indicate whether the location information report is successfully received by the target UE. For example, the feedback indication may be an RRC layer indication or LPP layer indication. Similar to the HARQ feedback, the feedback indication may include one of:
Success indication/failure indication: success indication for successful reporting and failure indication for failure reporting;
Failure indication only: failure indication for failure reporting and no feedback for successful reporting; and
Success indication only: success indication for successful reporting and no feedback for failure reporting.

Given the above, in the case that the location information report is successfully received by the target UE, the target UE may transmit a first indication indicating a successful reception of the location information report to the anchor UE (e.g., in the case of ACK/NACK feedback or ACK only feedback) or the target UE does not transmit any feedback (e.g., in the case of NACK only feedback). In such cases, the first indication may be an ACK feedback, a successful indication, or other indication indicating a successful reception of the location information report

In the case that the location information report is not successfully received by the target UE, the target UE may transmit a second indication indicating a failed reception of the location information report to the anchor UE (e.g., in the case of ACK/NACK feedback or NACK only feedback) or the target UE does not transmit any feedback (e.g., in the case of ACK only feedback). In such cases, the second indication may be a NACK feedback, a failure indication, or other indication indicating a failed reception of location information reporting. Then, in response to transmitting the second indication (e.g., in the case of ACK/NACK feedback or NACK only feedback) or in response to no feedback for the location information report (e.g., in the case of ACK only feedback), the target UE may receive a retransmission of the location information report from the anchor UE.

The embodiments described above may solve the resource conflict caused by multiple anchor UEs in an SL positioning group, thereby improving the sidelink positing performance.

The following embodiments may relate to ensuring latency bound for location information reporting to guarantee latency requirement for explicit request based location information reporting scenario.

In the explicit request based location information reporting scenario, as stated above, before receiving the location information report, the target UE may transmit the location information request to the anchor UE.

According to some embodiments of the present application, the target UE may start a timer in response to transmitting the location information request, wherein a value of the timer is set based on (for example, equal to or larger than than) a response time included in the location information request. The target UE may stop the timer in response to receiving the location information report from the anchor UE in step 703.

In an embodiment, the target UE may retransmit the location information request in response to expiration of the timer.

In another embodiment, the target UE may retransmit the location information request in response to expiration of the timer and that the target UE fails to receive the location information report from the anchor UE.

In yet another embodiment, the target UE may retransmit the location information request in response to expiration of the timer and that the target UE fails to receive any information (e.g., an error indication or a measurement report in the following embodiments) from the anchor UE.

In yet another embodiment, the target UE may retransmit the location information request in response to receiving information (e.g., an error indication or a measurement report in the following embodiments) from the anchor UE when the timer is running.

In yet another embodiment, the target UE may retransmit the location information request in response to receiving information (e.g., an error indication or a measurement report in the following embodiments) from the anchor UE when the timer expires or after the timer expires.

According to some embodiments of the present application, the target UE may retransmit the location information request in response to receive one of the following from the anchor UE:
an error indication with or without a cause value for failing to transmit the location information report; or
a measurement report currently obtained by the anchor UE (e.g., measured information that can be provided currently by the anchor UE) and a cause value for failing to transmit the location information report.

According to some embodiments of the present application, a leaving indication may be introduced to inform the target UE when the anchor UE is leaving the current sidelink positioning group.

For example, the target UE may receive a leaving indication from the anchor UE indicating that the anchor UE is leaving the current sidelink positioning group.

According to some embodiments of the present application, the target UE may receive the leaving indication from the anchor UE without location information along with the leaving indication.

According to some other embodiments of the present application, the leaving indication may be included in the location information report received in step 703, and the location information report may further include a measurement report currently obtained by the anchor UE (e.g., measured information that can be provided currently by the anchor UE). Alternatively, the leaving indication may be included in another message which further includes a measurement report currently obtained by the anchor UE (e.g., measured information that can be provided currently by the anchor UE).

FIG. 8 illustrates a simplified block diagram of an exemplary apparatus 800 for SL positioning according to some embodiments of the present application. In some embodiments, the apparatus 800 may be or include at least part of an anchor UE. In some other embodiments, the apparatus 800 may be or include at least part of a target UE.

Referring to FIG. 8, the apparatus 800 may include at least one transmitter 802, at least one receiver 804, and at least one processor 806. The at least one transmitter 802 is coupled to the at least one processor 806, and the at least one receiver 804 is coupled to the at least one processor 806.

Although in this figure, elements such as the transmitter 802, the receiver 804, and the processor 806 are illustrated in the singular, the plural is contemplated unless a limitation to the singular is explicitly stated. In some embodiments of the present application, the transmitter 802 and the receiver 804 may be combined to one device, such as a transceiver. In some embodiments of the present application, the apparatus 800 may further include an input device, a memory, and/or other components. The transmitter 802, the receiver 804, and the processor 806 may be configured to perform any of the methods described herein (e.g., the methods described with respect to FIGS. 6 and 7).

According to some embodiments of the present application, the apparatus 800 may be an anchor UE, and the transmitter 802, the receiver 804, and the processor 806 may be configured to perform operations of the method as described with respect to FIG. 6. For example, the receiver 804 is configured to receive SL positioning configuration information from a target UE, wherein the anchor UE helps the target UE to acquire its position. The transmitter 802 is configured to transmit a location information report to the target UE based on the positioning configuration information.

According to some embodiments of the present application, the apparatus 800 may be a target UE, and the transmitter 802, the receiver 804, and the processor 806 may be configured to perform operations of the method as described with respect to FIG. 7. For example, the transmitter 802 is configured to transmit SL positioning configuration information to an anchor UE, wherein the anchor UE helps the target UE to acquire its position. The receiver 804 is configured to receive a location information report from the anchor UE based on the positioning configuration information.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer-executable instructions, when executed, may cause the processor 806 to interact with the transmitter 802 and/or the receiver 804, so as to perform operations of the methods, e.g., as described with respect to FIGS. 6 and 7.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A first user equipment (UE) for wireless communication, comprising:
at least one memory; and
at least one processor coupled with the at least one memory and configured to cause the first UE to:
receive sidelink (SL) positioning configuration information from a second UE, wherein the first UE helps the second UE to acquire a position of the second UE; and
transmit a location information report to the second UE based on the positioning configuration information.

2. The first UE of claim 1, wherein the at least one processor is further configured to cause the first UE to:
receive a location information request from the second UE, wherein the location information request is used to request positioning measurements or a position estimate from the first UE; and
transmit the location information report to the second UE further based on the location information request.

3. The first UE of claim 2, wherein the at least one processor is further configured to cause the first UE to receive a resource configuration indicating a dedicated reporting resource for transmitting the location information report to the second UE, wherein the resource configuration is received along with the location information request, or included in the location information request.

4. The first UE of claim 2, wherein the at least one processor is further configured to cause the first UE to:
receive a groupcast signaling or broadcast signaling from the second UE or a system information block (SIB) information, wherein the groupcast signaling or broadcast signaling from the second UE or the SIB information includes a mapping relationship between a set of reporting resources and a set of UE identifications including an identification of the first UE; and
determine a dedicated reporting resource from the set of reporting resources for transmitting the location information report to the second UE based on the mapping relationship and the identification of the first UE.

5. The first UE of claim 2, wherein the at least one processor is further configured to cause the first UE to receive inter-UE coordination information from the second UE, wherein the inter-UE coordination information indicates a dedicated reporting resource for transmitting the location information report to the second UE.

6. The first UE of claim 2, wherein the location information request includes a response time specific for the first UE for a location service.

7. The first UE of claim 2, wherein the at least one processor is further configured to cause the first UE to:
receive, from the second UE, a first configuration indicating an area associated with the first UE and a second configuration indicating that the area is associated with a dedicated reporting resource or a dedicated resource pool; and
transmit the location information report to the second UE on the dedicated reporting resource or on a reporting resource in the dedicated resource pool.

8. The first UE of claim 2, wherein the at least one processor is further configured to cause the first UE to:
obtain an area mapping relationship between a set of areas and a set of UE identifications including an identification of the first UE, wherein the area mapping relationship is configured by the second UE or broadcasted in a system information block (SIB) information;
obtain a resource mapping relationship between the set of areas and a set of reporting resources or a set of resource pools, wherein the resource mapping relationship is configured by the second UE or broadcasted in the SIB information;
determine an area associated with the first UE from the set of areas based on the area mapping relationship and the identification of the first UE, and determine a dedicated reporting resource from the set of reporting resources or a dedicated resource pool from the set of resource pools based on the area associated with the first UE and the resource mapping relationship; and
transmit the location information report to the second UE on the dedicated reporting resource or on a reporting resource in the dedicated resource pool.

9. The first UE of claim 2, wherein the at least one processor is further configured to cause the first UE to:
start a timer in response to receiving the location information request, wherein a value of the timer is set based on a response time included in the location information request;
stop the timer in response to transmitting the location information report to the second UL;
in a case that the first UE fails to transmit the location information report before the timer expires:
transmit an error indication to the second UE; or
transmit a measurement report currently obtained by the first UE and a cause value for failing to transmit the location information report.

10. The first UE of claim 1, wherein the at least one processor is further configured to cause the first UE to:
start a timer in response to that the location information report becomes valid at the first UE, wherein a value of the timer is pre-configured for the first UE;
stop the timer in response to transmitting the location information report to the second UE; and
in a case that the first UE fails to transmit the location information report before the timer expires, cancel the location information report, and perform measurements in order to transmit a new location information report when the new location information report becomes valid.

11. The first UE of claim 1, wherein the at least one processor is further configured to cause the first UE to transmit a leaving indication to the second UE when at least one of:
a measured reference signal receiving power (RSRP) of sidelink positioning reference signal (SL-PRS) between the second UE and the first UE is smaller than or equal to a threshold within a time window;
a distance between the first UE and the second UE is larger than or equal to a threshold within a time window;
a channel busy ratio (CBR) or a channel occupancy ratio (CR) measured by the first UE is larger than or equal to a threshold within a time window; or
the first UE moves to a different area.

12. A second user equipment (UE) for wireless communication, comprising:
at least one memory; and
at least one processor coupled with the at least one memory and configured to cause the second UE to:
transmit sidelink (SL) positioning configuration information to a first UE, wherein the first UE helps the second UE to acquire a position of the second UE; and
receive a location information report from the first UE based on the positioning configuration information.

13. The second UE of claim 12, wherein the at least one processor is further configured to cause the second UE to:
transmit a location information request to the first UE, wherein the location information request is used to request positioning measurements or a position estimate from the first UE; and
receive the location information report from the first UE further based on the location information request.

14. The second UE of claim 13, wherein the at least one processor is further configured to cause the second UE to:
start a timer in response to transmitting the location information request, wherein a value of the timer is set based on a response time included in the location information request;
stop the timer in response to receiving the location information report from the first UE; and
retransmit the location information request in response to expiration of the timer.

15. A method performed by a first user equipment (UE), the method comprising:
receiving sidelink (SL) positioning configuration information from a second UE, wherein the first UE helps the second UE to acquire a position of the second UE; and
transmitting a location information report to the second UE based on the positioning configuration information.

16. A processor for wireless communication, comprising:
at least one controller coupled with at least one memory and configured to cause the processor to:
receive sidelink (SL) positioning configuration information from a user equipment (UE), wherein the processor helps the UE to acquire a position of the UE; and
transmit a location information report to the UE based on the positioning configuration information.

17. The processor of claim 16, wherein the at least one controller is further configured to cause the processor to:
receive a location information request from the UE, wherein the location information request is used to request positioning measurements or a position estimate from the processor;
transmit the location information report to the UE further based on the location information request; and
receive a resource configuration indicating a dedicated reporting resource for transmitting the location information report to the UE, wherein the resource configuration is received along with the location information request, or included in the location information request.

18. The processor of claim 16, wherein the at least one controller is further configured to cause the processor to:
receive a location information request from the UE, wherein the location information request is used to request positioning measurements or a position estimate from the processor;
transmit the location information report to the UE further based on the location information request;
receive a groupcast signaling or broadcast signaling from the UE or a system information block (SIB) information, wherein the groupcast signaling or broadcast signaling from the UE or the SIB information includes a mapping relationship between a set of reporting resources and a set of UE identifications including an identification of a UE that includes the processor; and
determine a dedicated reporting resource from the set of reporting resources for transmitting the location information report to the UE based on the mapping relationship and the identification of the UE that includes the processor.

19. The processor of claim 16, wherein the at least one controller is further configured to cause the processor to:
receive a location information request from the UE, wherein the location information request is used to request positioning measurements or a position estimate from the processor;
transmit the location information report to the UE further based on the location information request; and
receive inter-UE coordination information from the UE, wherein the inter-UE coordination information indicates a dedicated reporting resource for transmitting the location information report to the UE.

20. The processor of claim 16, wherein the at least one controller is further configured to cause the processor to:
receive a location information request from the UE, wherein the location information request is used to request positioning measurements or a position estimate from the processor;
transmit the location information report to the UE further based on the location information request;
receive, from the UE, a first configuration indicating an area associated with the processor and a second configuration indicating that the area is associated with a dedicated reporting resource or a dedicated resource pool; and
transmit the location information report to the UE on the dedicated reporting resource or on a reporting resource in the dedicated resource pool.
